(19) United States
(12) Patent Application Publication
(10) Pub. No.: US 2018/0109812 A1
(43) Pub. Date: Apr. 19, 2018

(54) BLOCK PARTITIONING USING TREE STRUCTURES

(71) Applicant: Media Tek Inc., Hsin-Chu (TW)

(72) Inventors: Chia-Ming Tsai, Hsinchu (TW); Chih-Wei Hsu, Hsinchu City (TW); Tzu-Der Chuang, Zhubei City (TW); Ching-Yeh Chen, Taipei City (TW); Yu-Wen Huang, Taipei City (TW)

(73) Assignee: Media Tek Inc., Hsin-Chu (TW)

(21) Appl. No.: 15/730,917

(22) Filed: Oct. 12, 2017

Related U.S. Application Data
(60) Provisional application No. 62/408,133, filed on Oct. 14, 2016.
(60) Provisional application No. 62/408,140, filed on Oct. 14, 2016.
(60) Provisional application No. 62/408,144, filed on Oct. 14, 2016.

(51) Int. Cl. H04N 19/66; H04N 19/64; H04N 19/96; H04N 19/119

(52) U.S. Cl. CPC H04N 19/66; H04N 19/119; H04N 19/96; H04N 19/647

(57) ABSTRACT

The techniques described herein relate to methods, apparatus, and computer readable media configured to encode an image or video. A slice is partitioned into a set of first units. For each first unit in the set of first units, the first unit is partitioned into a set of second units. The partitioning includes, for each second unit in the set of second units, determining whether the second unit satisfies a predetermined constraint. If the second unit does not satisfy the predetermined constraint, a first set of partitioning techniques is tested to partition the second unit. If the second unit satisfies the predetermined constraint, the first set of partitioning techniques and a second set of partitioning techniques are tested to partition the second unit. The second unit is partitioned using a technique from the first set of partitioning techniques or the second set of partitioning techniques identified by the testing.

### RELATED APPLICATIONS

This Application claims priority under 35 U.S.C. § 119(e) to U.S. Provisional Application Ser. No. 62/408,133, entitled “CONSTRAINTS FOR FLEXIBLE CODING UNIT PARTITION,” 62/408,140 entitled “METHODS AND APPARATUS OF ASYMMETRIC BLOCK PARTITION FOR VIDEO CODING,” and 62/408,144 entitled “METHODS AND APPARATUS OF TU PARTITION IN ASYMMETRIC BLOCK FOR VIDEO CODING,” each of which was filed on Oct. 14, 2016, and each of which is herein incorporated by reference in its entirety.

### TECHNICAL FIELD

The techniques described herein relate generally to image or video coding, and particularly to block partitioning using tree structures.

### BACKGROUND OF INVENTION

Video coding involves compressing (and decompressing) a digital video signal. Examples of video coding standards include the H.264 video compression standard, and its successor High Efficiency Video Coding (HEVC). HEVC is a project of the ITU-T Video Coding Experts Group (VCEG) and the ISO/IEC Moving Picture Experts Group (MPEG) standard organizations, working together in a partnership known as the Joint Collaborative Team on Video Coding (JCT-VC).

Moving video is formed by taking snapshots of the signal at periodic time intervals, such that playing back the series of snapshots, or frames, produces the appearance of motion. Video encoders include a prediction model that attempts to reduce redundancy using similarities between neighboring video frames. A predicted frame is created from one or more past or future frames that are often referred to as reference frames. Frames that do not serve as reference frames are often referred to as non-reference frames.

Since each frame of a video sequence can include thousands or millions of pixels, video coding techniques typically partition frames into slices. Each slice can be partitioned into multiple coding tree units (CTUs). For example, in the main profile, the minimum and the maximum sizes of the CTU are specified by the syntax elements in the sequence parameter set (SPS), which can include 8×8, 16×16, 32×32, and 64×64 (in pixels). The CTU is the basic unit of coding in HEVC, similar to a macroblock in other standards.

The CTU can be further partitioned into multiple coding units (CUs) to adapt to various local characteristics. The decision whether to code a picture area using Inter-picture (temporal) or Intra-picture (spatial) prediction is made at the CU level. Since the minimum CU size can be 8×8 pixels, the minimum granularity for switching different basic prediction types is 8×8 pixels. Each CU is transformed using one or more transform units (TUs), each of which is predicted using Intra or Inter prediction.

Various techniques can be used to partition a CTU into CUs (and/or further sub-CUs). However, it can be computationally expensive to test all possible partitioning techniques. Additionally, certain unit (CTU, CU) dimensions can be more computationally expensive to test than others, such as units with a length or a width that is not a power of two.

### SUMMARY OF INVENTION

In accordance with the disclosed subject matter, apparatus, systems, and methods are provided for decoder-side motion vector restoration techniques that improve the execution speed and efficiency of decoder-side motion vector refinement techniques.

Some embodiments relate to an image or video encoding method. The method includes partitioning a slice of an image or video sequence into a set of first units. For each first unit in the set of first units, the first unit is partitioned into a set of second units. Partitioning includes, for each second unit in the set of second units, determining whether the second unit satisfies a predetermined constraint. If the second unit does not satisfy the predetermined constraint, a first set of partitioning techniques is tested to partition the second unit. If the second unit satisfies the predetermined constraint, the first set of partitioning techniques and a second set of partitioning techniques are tested to partition the second unit. The second unit is partitioned using a technique from the first set of partitioning techniques or the second set of partitioning techniques identified by the testing.

In some examples, the first unit is a coding tree unit, and the second unit is a coding unit or a prediction unit.

In some examples, the first set of partitioning techniques includes a quad-tree partitioning technique that partitions the second unit using a quad-tree, a binary tree partitioning technique that partitions the second unit using a binary tree, a no partitioning technique that no further partitions in the second unit, or some combination thereof, and the second set of partitioning techniques includes an asymmetric coding unit partitioning technique that asymmetrically partitions the second unit, a triple-tree partitioning technique that partitions the second unit using a triple tree, or some combination thereof.

In some examples, the constraint comprises one or more of a coding unit size of the second unit, a tree split depth of the second unit, whether the second unit is a leaf node of a split tree, whether the coding unit width of the second unit is a power of two, whether the coding unit height of the second unit is a power of two, or any combination thereof.

In some examples, the constraint is implicitly indicated, explicitly indicated, or both.

In some examples, the method includes explicitly indicating the constraint in a video bitstream, wherein the constraint is signaled in a video parameter set (VPS), a sequence parameter set (SPS), a picture parameter set (PPS), a slice header, a coding unit, or any combination thereof.

In some examples, the constraint comprises a minimum length and a maximum length of a width of the second unit, a height of the second unit, a minimum and a maximum tree split depths, or any combination thereof.

Some embodiments relate to an image or video encoding method. A slice of an image or video stream is partitioned into a set of first units. For each first unit in the set of first units, the first unit is partitioned into a set of second units. Partitioning includes, for each second unit in the set of second units, determining whether the second unit satisfies a predetermined constraint. If the second unit satisfies the predetermined constraint, a first set of partitions are tested to partition the second unit, each partition from the set of partitions including a same partition direction. If the second unit does not satisfy the predetermined constraint, a second set of partitions is tested to partition the second unit, the partitions in the second set of partitions including the first set of partitions and additional partitions with a different direction than the first set of partitions. The second unit is partitioned using a partition from the first set of partitions or the second set of partitions identified by the testing.

In some examples, the constraint includes one or more of a minimum length and a maximum length of a width of the second unit, a height of the second unit, or both, whether the height of the second unit, the width of the second unit, or both, are a power of two, or any combination thereof.

In some examples, the method includes explicitly indicating the constraint in a video bitstream, wherein the constraint is signaled in a video parameter set (VPS), a sequence parameter set (SPS), a picture parameter set (PPS), a slice header, a coding unit, or any combination thereof.

In some examples, the constraint includes a minimum length and a maximum length of a width of the second unit, a height of the second unit, or both.

In some examples, a partitioning technique associated with the set of partitions is signaled.

Some embodiments relate to an image or video encoding method. The method includes partitioning a slice of an image or video stream into a set of first units. For each first unit in the set of first units, the first unit is partitioned into a set of second units. Partitioning the first unit includes, for each second unit in the set of second units, determining the second unit satisfies a predetermined constraint. A set of partitions is tested to partition the second unit, each partition from the set of partitions comprising a set of sub-units comprising a width meeting a second constraint, a height meeting the second constraint, or both. The second unit is partitioned using a partition from the set of partitions identified by the testing.

In some examples, the constraint comprises a width of the second unit not being a power of two, a height of the second unit not being a power of two, or both.

In some examples, the second constraint comprises the length being a power of two.

In some examples, the second constraint is implicitly determined based on a coding mode.

In some examples, the coding mode comprises an intra coding mode or an inter coding mode.

In some examples, the second constraint is explicitly indicated in a signal.

In some examples, the method further includes explicitly indicating the signal by a video parameter set (VPS), a sequence parameter set (SPS), a picture parameter set (PPS), a slice header, a coding unit, or any combination thereof.

In some examples, the constraint includes each side of the second unit is not a power of two, a series of values to split the side into many segments in power of two, or both.

In some examples, the first unit is a coding tree unit, and the second unit is a coding unit or a prediction unit.

Some embodiments relate to an apparatus configured to encode image or video data. The apparatus includes a processor in communication with memory. The processor is configured to execute instructions stored in the memory that cause the processor to partition a slice of an image or video sequence into a set of first units. For each first unit in the set of first units, the processor partitions the first unit into a set of second units. Partitioning includes, for each second unit in the set of second units determining whether the second unit satisfies a predetermined constraint. If the second unit does not satisfy the predetermined constraint, the processor tests a first set of partitioning techniques to partition the second unit. If the second unit satisfies the predetermined constraint, the processor tests the first set of partitioning techniques and a second set of partitioning techniques to partition the second unit. The processor partitions the second unit using a technique from the first set of partitioning techniques or the second set of partitioning techniques identified by the testing.

Some embodiments relate to an apparatus configured to encode image or video data. The apparatus includes a processor in communication with memory. The processor is configured to execute instructions stored in the memory that cause the processor to partition a slice of an image or video stream into a set of first units. For each first unit in the set of first units, the processor partitions the first unit into a set of second units, including, for each second unit in the set of second units, determining whether the second unit satisfies a predetermined constraint. If the second unit satisfies the predetermined constraint, the processor tests a first set of partitions to partition the second unit, each partition from the set of partitions comprising a same partition direction. If the second unit does not satisfy the predetermined constraint, the processor tests a second set of partitions to partition the second unit, the partitions in the second set of partitions including the first set of partitions and additional partitions with a different direction than the first set of partitions. The processor partitions the second unit using a partition from the first set of partitions or the second set of partitions identified by the testing.

Some embodiments relate to an apparatus configured to encode image or video data. The apparatus includes a processor in communication with memory. The processor is configured to execute instructions stored in the memory that cause the processor to partition a slice of an image or video stream into a set of first units. For each first unit in the set of first units, the processor partitions the first unit into a set of second units, including, for each second unit in the set of second units, determining the second unit satisfies a predetermined constraint. The processor tests a set of partitions to partition the second unit, each partition from the set of partitions comprising a set of sub-units comprising a width meeting a second constraint, a height meeting the second constraint, or both. The processor partitions the second unit using a partition from the set of partitions identified by the testing.

Some embodiments relate to an image or video decoding method. The method includes receiving a bitstream, wherein the bitstream was encoded by: partitioning a slice of an image or video sequence into a set of first units; for each first unit in the set of first units, partitioning the first unit into a set of second units, comprising, for each second unit in the set of second units: determining whether the second unit satisfies a predetermined constraint; if the second unit does not satisfy the predetermined constraint, testing a first set of partitioning techniques to partition the second unit; and if the second unit satisfies the predetermined constraint, testing the first set of partitioning techniques and a second set of partitioning techniques to partition the second unit; and partitioning the second unit using a technique from the first set of partitioning techniques or the second set of partitioning techniques identified by the testing. The method includes decoding the received bitstream.

In some examples, the constraint is explicitly indicated in the bitstream, wherein the constraint is signaled in a video parameter set (VPS), a sequence parameter set (SPS), a picture parameter set (PPS), a slice header, a coding unit, or any combination thereof.

Some embodiments relate to an image or video decoding method. The method includes receiving a bitstream, wherein the bitstream was encoded by: partitioning a slice of an image or video stream into a set of first units; for each first unit in the set of first units, partitioning the first unit into a set of second units, comprising, for each second unit in the set of second units: determining whether the second unit satisfies a predetermined constraint; if the second unit satisfies the predetermined constraint, testing a first set of partitions to partition the second unit, each partition from the set of partitions comprising a same partition direction; if the second unit does not satisfy the predetermined constraint, testing a second set of partitions to partition the second unit, the partitions in the second set of partitions including the first set of partitions and additional partitions with a different direction than the first set of partitions; and partitioning the second unit using a partition from the first set of partitions or the second set of partitions identified by the testing. The method includes decoding the received bitstream.

In some examples, the constraint is explicitly indicated in the bitstream, wherein the constraint is signaled in a video parameter set (VPS), a sequence parameter set (SPS), a picture parameter set (PPS), a slice header, a coding unit, or any combination thereof.

Some embodiments relate to an image or video decoding method. The method includes receiving a bitstream, wherein the bitstream was encoded by: partitioning a slice of an image or video stream into a set of first units; for each first unit in the set of first units, partitioning the first unit into a set of second units, comprising, for each second unit in the set of second units: determining the second unit satisfies a predetermined constraint; testing a set of partitions to partition the second unit, each partition from the set of partitions comprising a set of sub-units comprising a width meeting a second constraint, a height meeting the second constraint, or both; and partitioning the second unit using a partition from the set of partitions identified by the testing. The method includes decoding the received bitstream.

In some examples, the second constraint is explicitly indicated in the signal by a video parameter set (VPS), a sequence parameter set (SPS), a picture parameter set (PPS), a slice header, a coding unit, or any combination thereof.

Some embodiments relate to an apparatus configured to decode image or video data. The apparatus includes a processor in communication with memory. The processor is configured to execute instructions stored in the memory that cause the processor to receive a bitstream, wherein the bitstream was encoded by: partitioning a slice of an image or video sequence into a set of first units; for each first unit in the set of first units, partitioning the first unit into a set of second units, comprising, for each second unit in the set of second units: determining whether the second unit satisfies a predetermined constraint; if the second unit does not satisfy the predetermined constraint, testing a first set of partitioning techniques to partition the second unit; if the second unit satisfies the predetermined constraint, testing the first set of partitioning techniques and a second set of partitioning techniques to partition the second unit; and partitioning the second unit using a technique from the first set of partitioning techniques or the second set of partitioning techniques identified by the testing. The instructions cause the processor to decode the received bitstream.

Some embodiments relate to an apparatus configured to decode image or video data. The apparatus includes a processor in communication with memory. The processor is configured to execute instructions stored in the memory that cause the processor to receive a bitstream, wherein the bitstream was encoded by: partitioning a slice of an image or video stream into a set of first units; for each first unit in the set of first units, partitioning the first unit into a set of second units, comprising, for each second unit in the set of second units: determining whether the second unit satisfies a predetermined constraint; if the second unit satisfies the predetermined constraint, testing a first set of partitions to partition the second unit, each partition from the set of partitions comprising a same partition direction; if the second unit does not satisfy the predetermined constraint, testing a second set of partitions to partition the second unit, the partitions in the second set of partitions including the first set of partitions and additional partitions with a different direction than the first set of partitions; and partitioning the second unit using a partition from the first set of partitions or the second set of partitions identified by the testing. The instructions cause the processor to decode the received bitstream.

Some embodiments relate to an apparatus configured to decode image or video data. The apparatus includes a processor in communication with memory. The processor is configured to execute instructions stored in the memory that cause the processor to receive a bitstream, wherein the bitstream was encoded by: partitioning a slice of an image or video stream into a set of first units; for each first unit in the set of first units, partitioning the first unit into a set of second units, comprising, for each second unit in the set of second units: determining the second unit satisfies a predetermined constraint; testing a set of partitions to partition the second unit, each partition from the set of partitions comprising a set of sub-units comprising a width meeting a second constraint, a height meeting the second constraint, or both; and partitioning the second unit using a partition from the set of partitions identified by the testing. The instructions cause the processor to decode the received bitstream.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows an exemplary video coding configuration, according to some embodiments.

FIG. 2 shows an exemplary subdivision of a coding tree unit (CTU) into coding units (CUs) and transform units (TUs), and an associated quad tree.

FIG. 3 shows an exemplary Quad-Tree-Binary-Tree (QTBT) partitioning of a coding tree unit (CTU) and a resulting QTBT tree structure.

FIG. 4 illustrates quad tree (QT), binary tree (BT), and triple-tree (TT) partitions.

FIG. 5 shows four asymmetric partitions.

FIG. 6 shows an exemplary process for constraining CTU partitioning for image or video encoding, according to some embodiments.

FIG. 7 illustrates an example of a tree with coding units (CUs) at leaf nodes, used to test for asymmetric and/or triple-tree (TT) partitioning, according to some embodiments.

FIG. 8 shows an exemplary method for only testing certain directions during partitioning, according to some embodiments.

FIG. 9 shows an example of only testing a horizontal split, according to some embodiments.

FIG. 10 shows an example of testing based on whether a side is a power of two, according to some embodiments.

FIG. 11 shows an example of early termination based on whether a side is a power of two, according to some embodiments.

FIG. 12 illustrates an exemplary method for partitioning a coding unit (CU) when the height or width of the CU is not a power of two, according to some embodiments.

FIG. 13 shows examples of implicitly indicating the transform unit (TU) partition, according to some embodiments.

FIG. 14 shows examples of implicitly indicating the transform unit (TU) partition, according to some embodiments.

FIG. 15 shows examples of implicitly indicating the transform unit (TU) partition according to coding mode, according to some embodiments.

### DETAILED DESCRIPTION OF INVENTION

The inventors have recognized and appreciated that various techniques can be used to improve the execution of CTU partitioning. Although recursively splitting a CTU into CUs using a number of different partitioning techniques (e.g., no partition, quad tree (QT), binary tree (BT), triple-tree (TT), and asymmetric partitions) can create coding efficiencies, it may not be the best approach and also complicate the video codec design. For example, testing too many different partitioning types can consume significant computational time. As another example, a large number of transform types may need to be supported, such as for units (e.g., coding units) with either a width or height that is not a power of two.

The inventors have therefore developed techniques to limit the usage of CU partitioning techniques, such as limiting the use of TT and asymmetric partitioning (e.g., in addition to QT, BT, and no partitioning). The inventors have also developed techniques to divide a unit (e.g., a coding unit) with a width or height that is not a power of two into a number of sub-units (e.g., sub-transform units) that each has a width and height that is a power of two. Limiting the use of too many partitioning techniques can not only save computational resources but also save signaling overhead. Further, the inventors have developed techniques to implicitly determine the partition for a block based on the block height, the block width, and/or the coding mode.

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

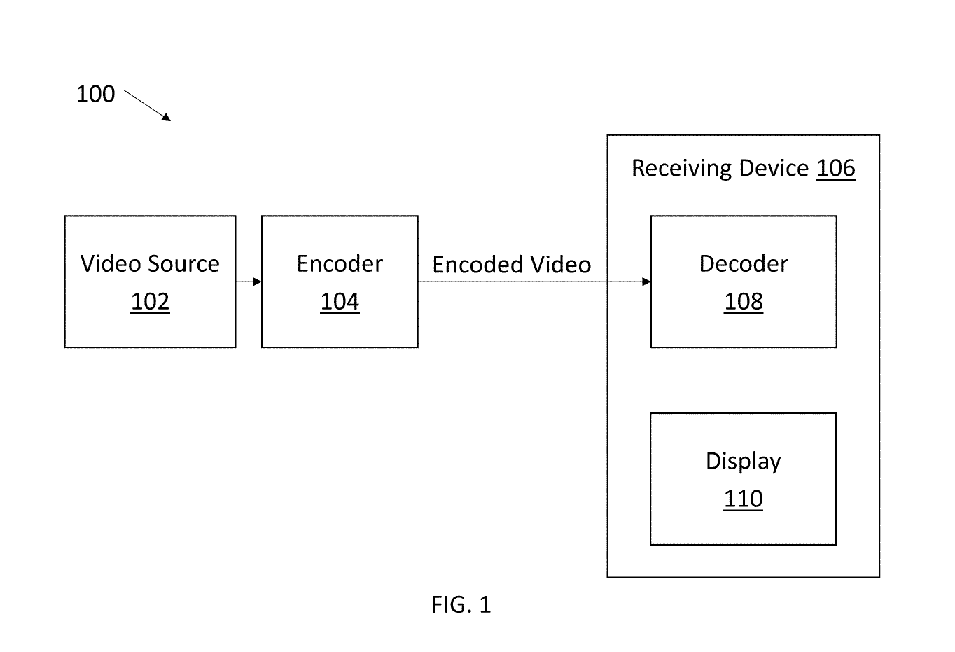

FIG. 1 shows an exemplary video coding configuration 100, according to some embodiments. Video source 102 is an image and/or video source, and can be, for example, digital television, internet-based video, video calling, and/or the like. Encoder 104 encodes the video from the video source 102 into encoded video. The encoder 104 can reside on the same device that generated the video source 102 (e.g., a cell phone, for video calling), and/or may reside on a different device. The receiving device 106 receives encoded video from the encoder 104. The receiving device 104 may receive the video as a video product (e.g., a digital video disc, or other computer readable media), through a broadcast network, through a mobile network (e.g., a cellular network), and/or through the Internet. The receiving device 106 can be, for example, a computer, a cell phone, or a television. The receiving device 106 includes a decoder 108 that is configured to decode the encoded video. The receiving device 106 also includes a display 110 for displaying the decoded video.

As explained above, part of the encoding process may include partitioning a CTU into multiple CUs. In some examples, the encoder (e.g., encoder 104) uses a tree to partition the CTU into multiple CUs, such as a coding tree. For example, HEVC uses an adaptive CU partition. The CTU is sized M×M pixels, where M is one of 16, 32 or 64 pixels. The CTU may be a single CU, or the CTU may be split into smaller units of equal sizes of M/2×M/2, which are the nodes of the resulting coding tree. If units are leaf nodes of the coding tree, the units become CUs. Otherwise, the quadtree splitting process can be iterated until the size of a node reaches a minimum allowed CU size (e.g., specified in the SPS). This results in a recursive structure specified by a coding tree.

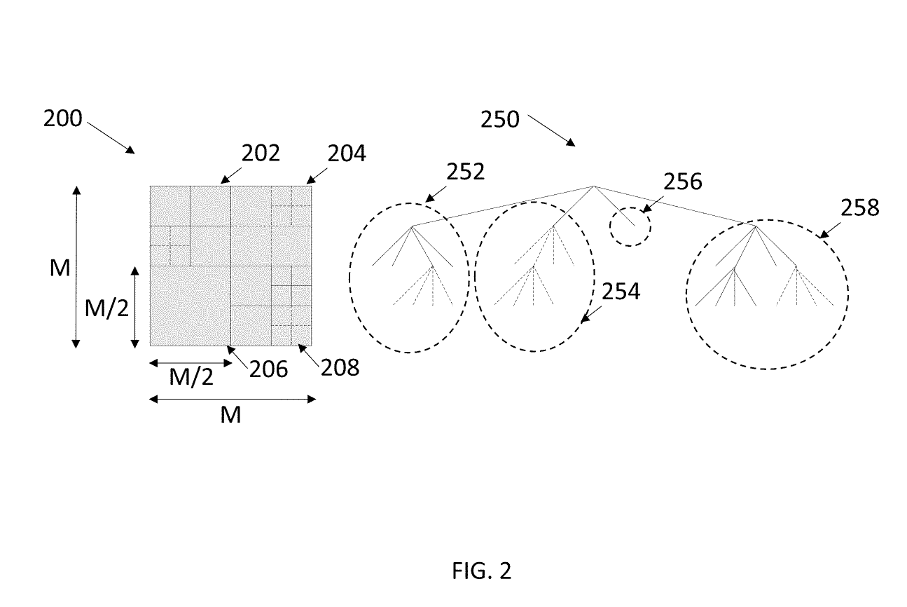

FIG. 2 shows an exemplary subdivision of a CTU 200 using a quad tree (QT) into CUs and transform units (TUs), and an associated quad tree 250. The solid lines indicate CU boundaries, and the dotted lines indicate TUs. The CTU 200 is divided into four CUs 202, 204, 206 and 208. CU 202 is further divided into four sub-CUs, and the lower-left sub-CU is further divided into four TUs shown with the dotted lines. CU 202 corresponds to portion 252 of the quad tree 250. CU 204 is divided into four TUs, and the upper-right TU is divided into four sub-TUs. CU 204 corresponds to portion 254 of the quad tree 250. CU 206 is not divided, and corresponds to portion 256 of the quad tree 250. CU 208 is divided into four CUs, and the upper-right CU is divided into four sub-CUs and the lower-right CU is divided into four TUs. CU 208 corresponds to portion 258 of the quad tree 250. Therefore, as shown in FIG. 2, quad tree partitioning is used to partition not only the CTU but also recursively on other partitions (or nodes) in the quad tree.

One or more prediction units PUs are specified for each CU. Coupled with the CU, the PU works as a basic representative block for sharing the prediction information. Inside one PU, the same prediction process is applied and the relevant information is transmitted to the decoder on a PU basis. A CU can include, or be split into, one, two or four PUs according to the PU splitting type. HEVC defines different splitting types for splitting a CU into a PU.

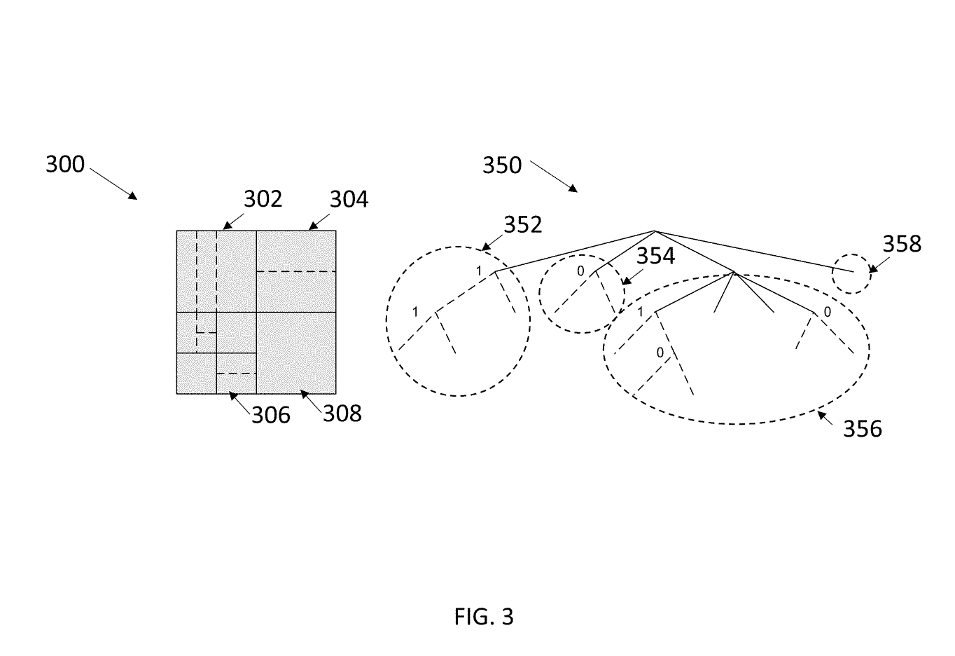

In addition to QT, other structures can be used to partition a CTU into CUs. For example, the Quad-Tree-Binary-Tree (QTBT) can be used, which can have a better coding performance compared to QT structure. The QTBT is described in, for example, J. An et al., “Block partitioning structure for next generation video coding,” MPEG doc. m37524 and ITU-T SG16 Doc. COM16-C966, October 2015, which is hereby incorporated by reference herein in its entirety. FIG. 3 shows an exemplary QTBT partitioning of CTU 300 and resulting QTBT tree structure 350. For a QTBT, the CTU 300 is first partitioned by a QT. CTU 300 is partitioned using QT into the four leaf nodes 302, 304, 306 and 308. CU 306 is further partitioned by a QT into four leaf nodes. The QT leaf nodes are then partitioned by a binary-tree (BT) structure. Leaf node 302 is partitioned twice—once vertically, and the left portion is further partitioned vertically. Leaf node 302 corresponds to portion 352 in the QTBT 350. Leaf node 304 is partitioned once horizontally, and corresponds to portion 354 in the QTBT 350. Two of the four leaf nodes in 306 are partitioned using a BT—the upper-left is partitioned twice (once vertically and then the right partition is further portioned once horizontally), and the lower-right is partitioned once horizontally. Leaf node 306 corresponds to portion 356 in the QTBT 350. Leaf node 308 is not partitioned, and corresponds to portion 358 in the QTBT 350. After constructing the binary tree structure, binary-tree leaf nodes are denoted as CUs, which are used for prediction and transform without any further partitioning.

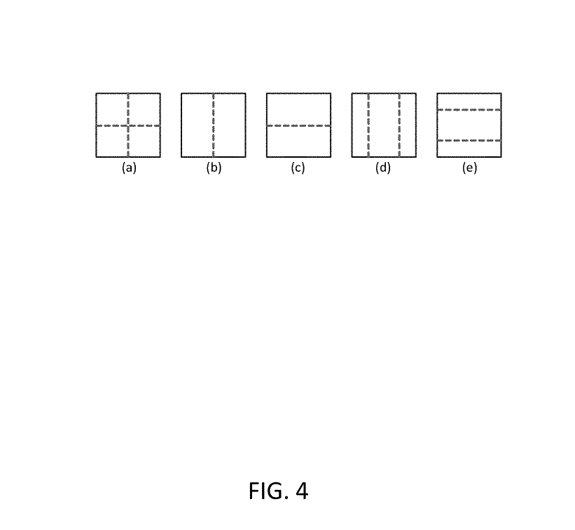

In addition to QT and BT, another exemplary portioning technique is triple-tree (TT) partitioning. TT partitioning can be employed to capture objects in the center of blocks. FIG. 4 illustrates QT partition (a), vertical BT partition (b), horizontal BT partition (c), vertical center-side TT partition (d), and horizontal center-side TT partition (e). For example, for TT partitioning, the CTU is first partitioned by a quad-tree (e.g., partition (a)). The quad-tree leaf nodes are further partitioned by a sub-tree that contains both BT and TT partitions (e.g., partitions (b) through (e) in FIG. 4). After constructing the sub-tree structure, the sub-tree leaf nodes are denoted as CUs, which are used for prediction and transform without any further processing.

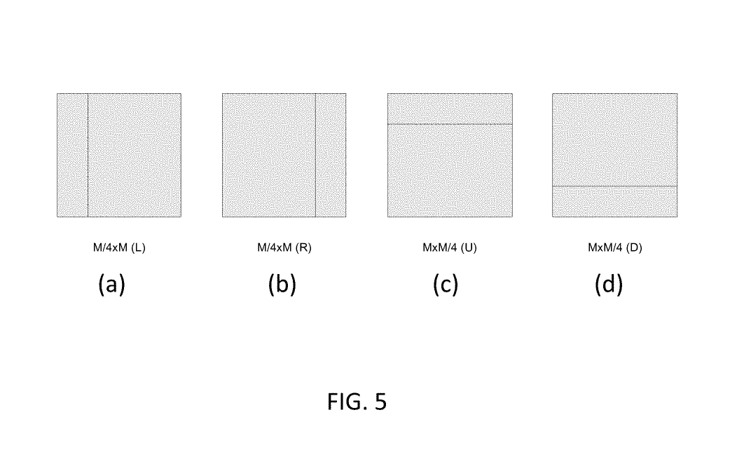

Further, asymmetric horizontal and vertical splitting types can also be selected (e.g., besides the symmetric horizontal and vertical splitting types for BT). FIG. 5 shows four asymmetric partitions (a)-(d). Assuming a length and width of M, partition (a) partitions the unit vertically at M/4 from the left, partition (b) partitions the unit vertically at M/4 from the right, partition (c) partitions the unit horizontally at M/4 from the top, and partition (d) partitions the unit horizontally at M/4 from the bottom. For example, after constructing a BT structure as described above, the BT leaf nodes (the CUs) are used for prediction and transform without further processing. The asymmetric partitions can be tested on the BT CUs to further develop the tree structure.

Therefore, various types of partitions can be used to partition CTUs and CUs, including QT, BT, TT and asymmetric partitions. The TT and asymmetric partitions were proposed in addition to QT and BT. See, for example, F. Le Leannec, “Asymmetric Coding Unit in QTBT,” JVET-D0064, October 2016, which describes asymmetric partitioning, and X. Li, “Multi-Type-Tree,” JVET-D0117, October 2016, which describes TT partitioning, the contents of which are hereby incorporated by reference herein in their entirety. However, while TT and asymmetric partitioning can further improve the coding efficiency compared to just QT and BT, there can also be issues using these various techniques. For example, when checking a particular unit (e.g., a coding unit) for the best partition type, checking too many partitioning techniques can increase the computational time to generate the coding structure.

As another example, if the unit (e.g., a coding unit) width and/or height is not a power of two, the coding technique may need to support many different transform types in order to handle a non-power of two dimension in the unit being partitioned. Consider, for example, a technique that leverages QT and BT, where the size of the TU is equal to the size of the CU (e.g., such that one CU should be one TU, and the CU is not further partitioned into more than one TU). If the technique leverages five different CU sizes, then the technique uses five different TUs. Therefore, as the number of CU sizes grows, more transform units are required. Using different partition techniques (e.g., TT, BT, asymmetric partitioning) generates further CU sizes, and therefore requires more TUs. To illustrate, assume as an example that the transform process is performed by applying a one-dimensional (1-D) transform twice. For example, one TU is processed by a 1-D horizontal transform first, followed by a 1-D vertical transform. For some techniques that use QT+BT, the sizes in one direction of all possible CUs may always be a power of two. Thus, the technique can reuse these 1-D transforms for different CUs. For example, the technique can reuse a 1-D horizontal transform for those CU with size equal to 16×N (where N is integer). However, asymmetric partitions generate more CUs with sizes that are not a power of two, e. g. 12×16, or 32×24. Such a coding technique, using asymmetric partitions, therefore needs to create the corresponding transform to meet the constraint that one CU is equal to one TU in the original design of QT+BT.

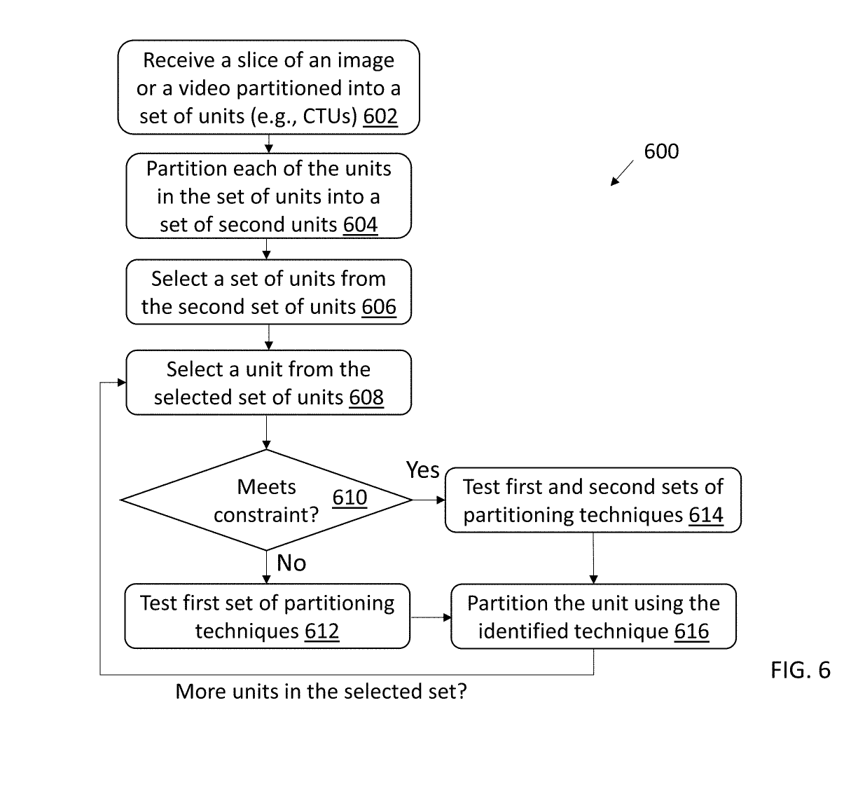

FIG. 6 shows an exemplary process 600 for constraining CTU partitioning for image or video encoding, according to some embodiments. At step 602, the encoder receives a slice of an image or of a video that is partitioned into a set of first units (e.g., CTUs). At step 604, the encoder partitions each unit in the set of first units into a set of second units (e.g., CUs). At step 606, the encoder selects a set of units from the set of second units. At step 608, for each unit in the selected set of units. The encoder executes steps 610-616 to partition the selected unit. At step 610, the encoder determines whether the selected unit meets a predetermined constraint. If the unit does not satisfy the predetermined constraint, at step 612 the encoder tests a first set of partitioning techniques to partition the second unit. If the unit satisfies the predetermined constraint, at step 614 the encoder tests the first set of partitioning techniques and a second set of partitioning techniques to partition the unit. Steps 612 and 614 identify a resulting technique (or no technique at all if the second unit is not to be partitioned further). At step 616, the encoder partitions the second unit using the identified technique from the first set of partitioning techniques or the second set of partitioning techniques. The method 600 proceeds back to step 608 to test each unit in the selected set of units. While not shown in FIG. 1, the method 600 also tests the remaining sets of units in the second set of units using steps 608-616. Further, while not shown in method 600, the method can be run on the partitions generated at step 616 in an iterative fashion (e.g., to further partition the partitions made at step 616).

Referring to steps 602 and 604, the set of units can be CTUs, and the set of second units can be nodes in a tree. For example, the set of second units for each CTU can be a set of CUs, TUs, or other nodes within a tree.

Referring to step 610, the constraint can be one or more of a coding unit size of the unit, a tree split depth of the unit, whether the unit is a leaf node of a split tree; whether the coding unit width of the second unit is a power of two; whether the coding unit height of the second unit is a power of two, and/or the like. The constraint(s) can be implicitly indicated, explicitly indicated, or both. For a first illustrative example, an implicit indication is based on the CU size. For a first illustrative example, if the current CU size is larger than 16×16, the technique can allow TT and asymmetric partitions (e.g., the second set of partitioning techniques includes TT and asymmetric partitioning). Otherwise, if the current CU size is not larger than 16×16, only BT is used (e.g., the first set of partitioning techniques is BT). For a second illustrative example, an implicit indication is based on the QT node. For example, if the current CU is partitioned by QT, then the technique allows TT (e.g., the second set of partitioning techniques is TT). Otherwise, if the current CU is not partitioned by QT, only BT can be used (e.g., first set of partitioning techniques is BT). For a third illustrative example, the CU size constraint can be explicitly signaled by the slice header. For example, if current CU size is larger than the signaled threshold, then the technique allows TT and asymmetric partitioning (e.g., the second set of partitioning techniques includes TT and asymmetric partitioning). Otherwise, if the current CU size is not larger than the signaled threshold, only BT can be used (e.g., the first set of partitioning techniques is BT).

Referring to steps 612 and 614, the first set of partitioning techniques can be, for example, QT and/or BT. The second set of partitioning techniques can be TT and/or asymmetric partitioning. In such embodiments, step 612 only tests QT and/or BT, while step 614 tests (a) QT and/or BT and (b) TT and/or asymmetric partitioning. Therefore, a video coding system can use various prediction modes to encode one CU, where one prediction mode essentially defines one rule to generate the predictors. In some embodiments, in order to find the best predictor (e.g., one that removes the most amount of redundancy), a cost function is defined to jointly consider the coding bits and the distortion value when using a particular mode decision, and then the mode decision process tests all prediction modes to select the prediction mode with the smallest cost. In some examples, the cost function is a linear combination value of coding bits and distortion. For example, J=D+λR is an example of a cost function where D is the distortion value, R is the coding bits, and λ is a slope value to balance the preference between D and R. Therefore, in some examples, for each partition method, the video coding system can perform the mode decision process to find the best prediction mode(s) for the CUs in this partition method and calculate the total costs of these best prediction mode(s). The partition method(s) with the smallest total cost is selected as the best partition method(s) among the different partition methods.

The constraint technique discussed in conjunction with FIG. 6 can improve the flexible coding unit partition for higher coding efficiency and/or less encoder complexity. In some embodiments, during a sub-tree partition, the second set of partitioning techniques (e.g., TT partition and/or asymmetric partition) are jointly tested with the first set of partitioning techniques for the CUs when the CU size is between the minimal and maximum allowed CU sizes. For example, let the maximum allowed CU size be denoted as M, the minimal allowed CU size be denoted as m, and the current CU size be denoted by s. If m≤s=M, then second set of partitioning techniques are jointly tested for the current CU. Otherwise, for example, only the BT partition is tested in addition to the QT partition.

In some embodiments, during the sub-tree partition, the second set of partitioning techniques are jointly tested with the first set of partitioning techniques for the CUs when the corresponding binary tree depth is between the minimal and maximum allowed tree depths. For example, let the maximum allowed tree depth be denoted as D, the minimal allowed tree depth be denoted as d, and the current CU depth be t. If d≤t≤D, then the second set of partitioning techniques are jointly tested for the current CU. Otherwise, for example, only the BT partition is tested in addition to QT.

In some embodiments, the constraints can be different for different techniques (e.g., for TT and asymmetric partition). For example, for a tree depth constraint, the depth constraint for TT could be 0≤t≤2, and the depth constrain for asymmetric partition could be 0≤t≤3.

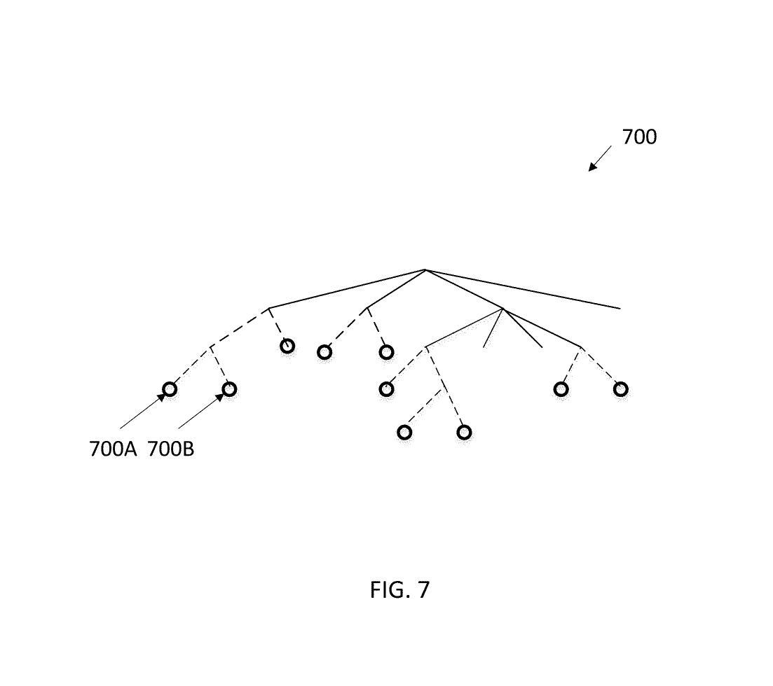

In some embodiments, during the sub-tree partition, the second set of partitioning techniques are jointly tested for the CUs when the CU location is at the leaf node of binary tree. Otherwise, for example, only BT partitioning is tested in conjunction with QT. FIG. 7 illustrates an example of a tree 700 with CUs at leaf nodes 702A, 702B, and so on (collectively referred to as leaf nodes 702), to test for the second set of partitioning techniques, according to some embodiments. At each leaf node 702 the encoder jointly tests the second set of partitioning techniques.

In some embodiments, during the sub-tree partition, the second set of partitioning techniques are jointly tested with the first set of partitioning techniques for the CUs when the CU size of using the first set of partitioning techniques is between the minimal and maximum allowed CU sizes; meanwhile, the corresponding binary tree depth is between the minimal and maximum allowed tree depths. For example, let the maximum allowed CU size be denoted as M, the minimal allowed CU size be denoted as m, the maximum allowed tree depth be denoted as D, the minimal allowed tree depth be denoted as d. And the CU size of using the first set of partitioning techniques is s and the current CU depth be t. If m≤s≤M and d≤t≤D, then the second set of partitioning techniques are jointly tested for the current CU. Otherwise, only the first set of partitioning techniques is tested.

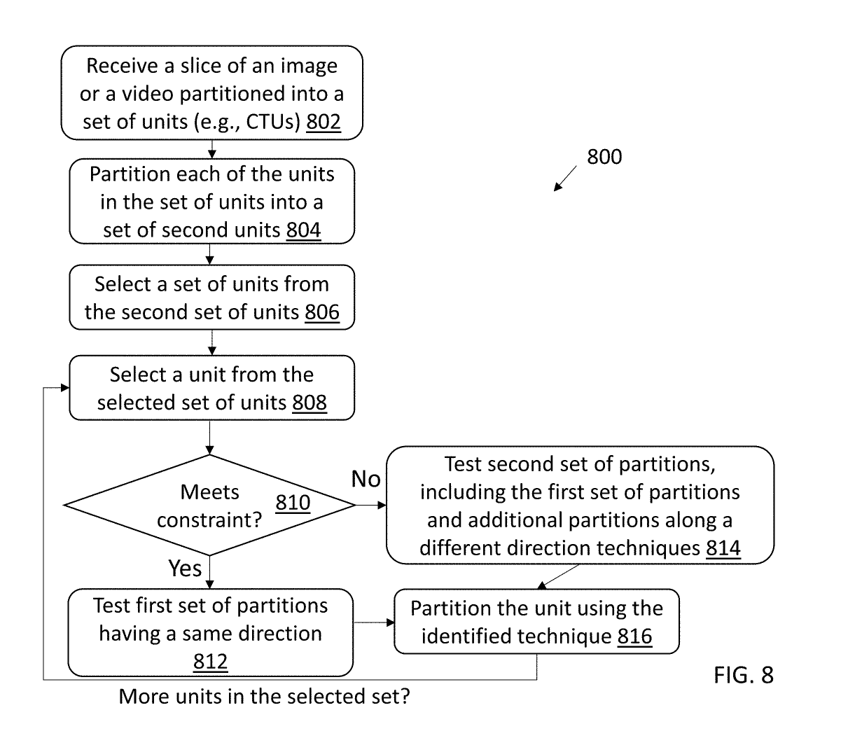

In some embodiments, the techniques can be configured so that only certain directions are tested for partitioning. FIG. 8 shows an exemplary method 800 for only testing certain directions during partitioning, according to some embodiments. At step 802, the encoder receives a slice of an image or of a video that is partitioned into a set of first units (e.g., CTUs). At step 804, the encoder partitions each unit in the set of first units into a set of second units. At step 806, the encoder selects a set of units from the set of second units. At step 808, the encoder selects a unit from the selected set of units. The encoder executes steps 810-816 to partition the selected unit. At step 810, the encoder determines whether the selected unit meets a constraint. If the unit satisfies the predetermined constraint, at step 812 the decoder tests a first set of partitions to partition the unit, each partition from the set of partitions having a same partition direction. If the unit does not satisfy the predetermined constraint, at step 814 the decoder tests a second set of partitions to partition the unit, the partitions in the second set of partitions including the first set of partitions and additional partitions with a different direction than the first set of partitions. At step 816, the encoder partitions the unit using a partition from the first set of partitions or the second set of partitions identified by the testing. The method 800 returns back to step 808 and executes steps 810-816 on each remaining unit in the selected set of units. While not shown in FIG. 8, the method can run steps 808-816 on each set of units in the second set of units. Further, while not shown in method 800, the method can be run on the partitions generated at step 816 in an iterative fashion (e.g., to further partition the partitions made at step 816).

Referring to step 810, the constraint can be one or more of a minimum length and a maximum length of a width of the second unit, a height of the second unit, or both, and/or whether the length of the height of the second unit, the width of the second unit, or both, are a power of two, and/or the like.

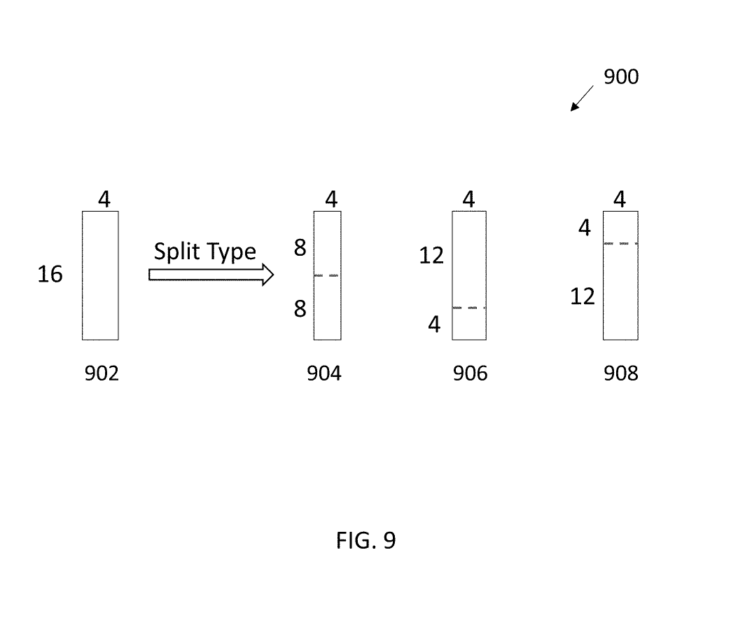

In some embodiments, to reduce the possible overhead in indicating the block partition direction, only one block partition direction is tested once the CU width or CU height is qualified for the minimal and maximum allowed length. For example, let the maximum allowed length be denoted as L, the minimal allowed tree depth be denoted as l, and the current CU width and height be w and h, respectively. In some examples, if l≤w≤L, then only the horizontal block partition types are jointly tested for the current CU (e.g., jointly tested in addition to QT partitions, or jointly tested among horizontal BT, horizontal TT, and horizontal asymmetric partitions). FIG. 9 shows an example of only testing a horizontal split, according to some embodiments. As shown in FIG. 9, CU 902 has a width of 4 and a height of 16, and is tested for splitting. Since the width w is equal to four (the width w is tested to see whether it is greater than or equal to 0, and less than or equal to 4), then only the horizontal split direction is allowed. FIG. 9 shows testing a binary split 904 and two asymmetric splits 906 and 908. If one of the horizontal block partition types is selected as the final CU split method, then the binary split direction is implicitly indicated. Similarly, in another embodiment, if l≤h≤L, then only the vertical block partition types are jointly tested for the current CU. The binary split direction is therefore implicitly indicated once the vertical block partition type is finally selected. The horizontal or vertical block partition types could be either symmetric and/or asymmetric block partition types.

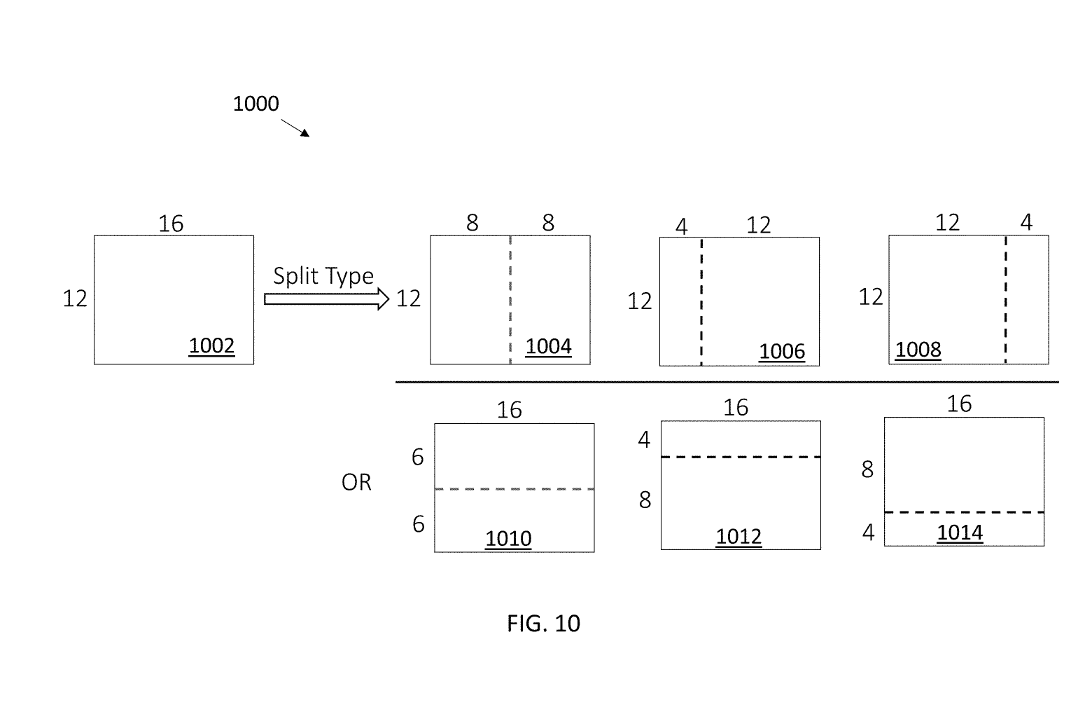

In some embodiments, to reduce the possible overhead in indicating the block partition direction, only one block partition direction is tested once the CU width or CU height is not a power of 2. FIG. 10 shows an example of testing based on whether a side is a power of two, according to some embodiments. The CU 1002 has a height of 12 and a width of 16. According to a first example, the vertical binary partition 1004 and vertical asymmetric partitions 1006 and 1008 are tested. According to a second example, the horizontal binary partition 1010 and horizontal asymmetric partitions 1012 and 1014 are tested. For example, if the CU width is not a power of 2, then only the horizontal block partition types (e.g., 1010, 1012, and 1014) are jointly tested for the current CU. If one of the horizontal block partition types is selected as the final CU split method, then the binary split direction is implicitly indicated. Similarly, in another embodiment, if the CU height is not the power of 2, then only the vertical block partition types (e.g., 1004, 1006, 1008) are jointly tested for the current CU. The binary split direction is implicitly indicated once the vertical block partition type is finally selected. The horizontal or vertical block partition types could be either symmetric and/or asymmetric block partition types.

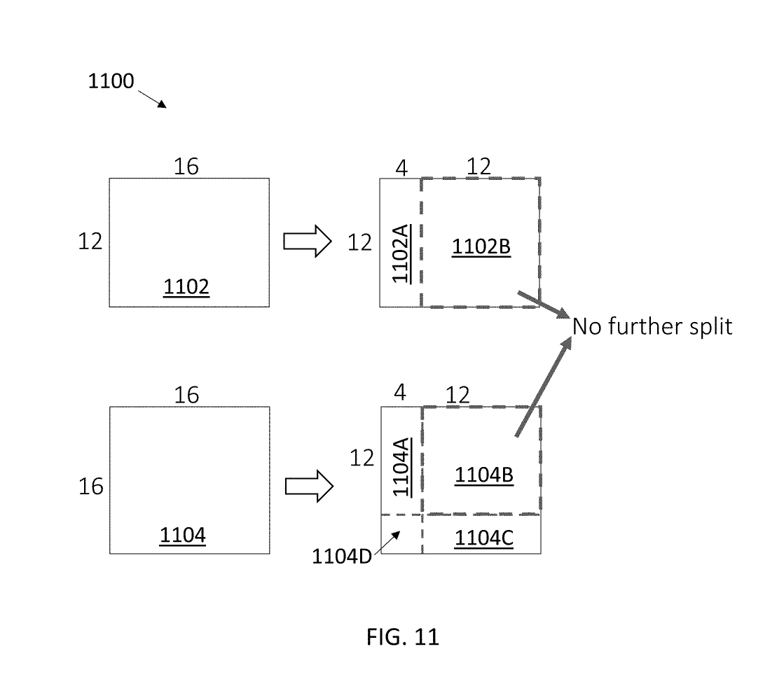

In some embodiments, to reduce the possible overhead in indicating the block splitting syntax elements, the block partition process is early terminated if both the CU width and CU height are not a power of 2. For example, in one embodiment, the quad tree splitting process will be early terminated once the CU width and CU height are not a power of 2. No further CU splitting syntax is indicated. Similarly, in some embodiments, the binary tree splitting process will be early terminated once the CU width and CU height are not a power of 2. No further CU splitting syntax is indicated. FIG. 11 shows an example 1100 of early termination based on whether a side is a power of two, according to some embodiments. For CU 1102, when splitting into sub-CUs 1102A and 1102B, since neither the height nor the width of sub-CU 1102B is a power of two, the block partition process is early terminated for sub-CU 1102B. For CU 1104, when splitting into sub-CUs 1104A through 1104D, since neither the height nor the width of sub-CU 1104B is a power of two, then the block partition process is early terminated for sub-CU 1104B.

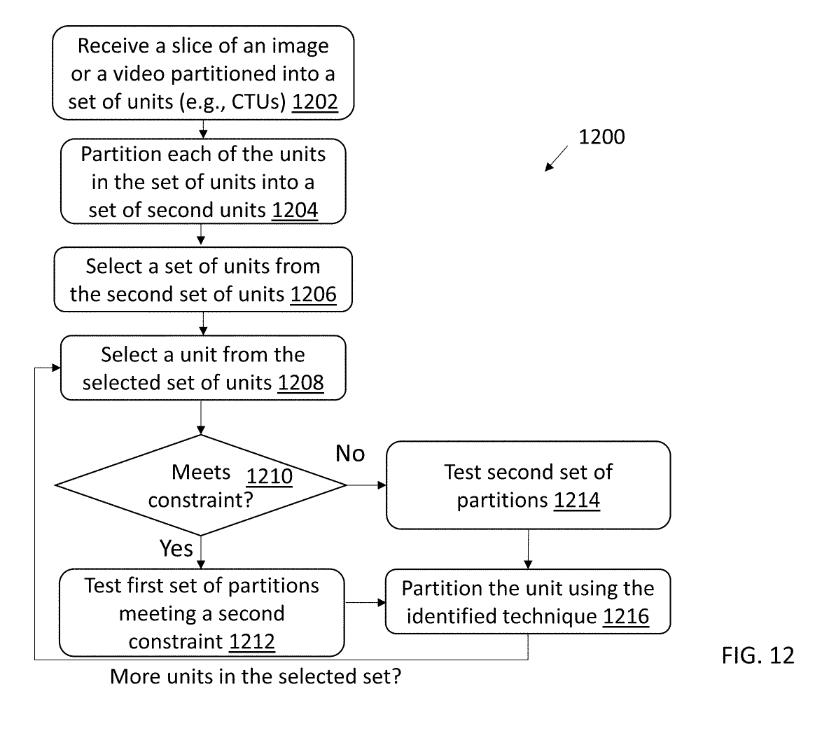

FIG. 12 illustrates an exemplary method 1200 for partitioning a CU when the height or width of the CU is not a power of two, according to some embodiments. At step 1202, the encoder receives a slice of an image or of a video that is partitioned into a set of units (e.g., CTUs). At step 1204, the encoder partitions each unit in the set of units into a set of second units. At step 1206, the encoder selects a set of units from the set of second units. At step 1208, the encoder selects a unit from the selected set of units. The encoder executes steps 1210-1216 to partition the selected unit. At step 1210, the encoder determines whether the selected unit meets a constraint. If the unit meets the constraint, the encoder tests a first set of partitions to partition the unit, each partition from the first set of partitions comprising a plurality of sub-units, each sub-unit comprising a width meeting a second constraint (e.g., a power of two), a height meeting the second constraint, or both. If the unit does not meet the constraint, at step 1214 the encoder tests a second set of partitions. The second set of partitions may include the first set of partitions and/or may include other partitions not meeting the second constraint. At step 1216, the encoder partitions the unit using a partition from the set of partitions identified by the testing. The method 1200 returns back to step 1208 and executes steps 1210-1216 on each remaining unit in the selected set of units. While not shown in FIG. 12, the method can run steps 1208-1216 on each set of units in the second set of units. Further, while not shown in method 1200, the method can be run on the partitions generated at step 1216 in an iterative fashion (e.g., to further partition the partitions made at step 1216).

Referring to step 1210, the constraint can include a width of the second unit not being a power of two, a height of the second unit not being a power of two, or both. Referring to step 1212, the second constraint can be the length of the height or width, or both, of the sub-units being a power of two.

Referring to steps 1212 and 1214, the sets can include splitting types such as the symmetric vertical splitting (e.g., shown in FIG. 4 as (b)), symmetric horizontal splitting (e.g., shown in FIG. 4 as (c)), and/or one or more asymmetric splitting types shown in FIG. 5 as (a)-(d).

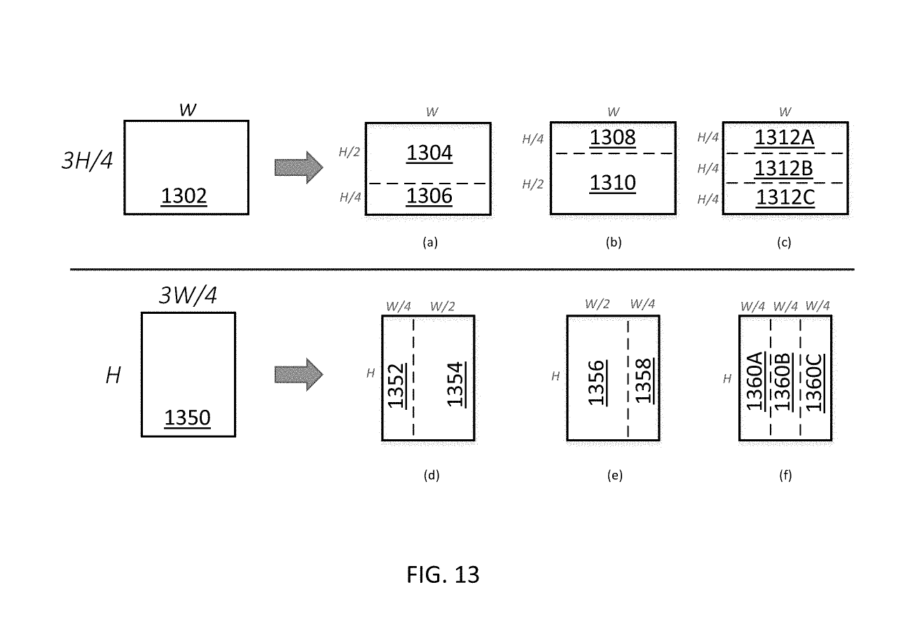

In some embodiments, if a block height is not a power of 2, then the TU partition of the block is implicitly indicated. There are several methods that can be used to implicitly indicate (e.g., or to determine) the TU partition. FIG. 13 shows examples of implicitly indicating the TU partition, according to some embodiments. Block 1302 has a width of W and a height of 3H/4. In one example, the TU partition for block 1302 is composed of a W×H/2 TU 1304 and then a W×H/4 TU 1306, as shown in (a). In another example, the TU partition for block 1302 is composed of a W×H/4 block 1308 and then a W×H/2 block 1310, as shown in (b). In another example, the TU partition is composed of three W×H/4 transform blocks 1312A-C, as shown in (c).

In some embodiments, if a block width is not a power of 2, then the TU partition of the block is implicitly indicated. Again, there are several methods that can be used to implicitly indicate (e.g., or to determine) the TU partition. Referring further to FIG. 13, block 1350 has a height H and a width 3W/4. For example, the TU partition of block 1350 is composed of a W/2×H TU 1352 and a W/4×H TU 1354, as shown in (d). As another example, the TU partition for block 1350 is composed of a W/4×H TU 1358 and then a W/2×H TU 1356, as shown in (e). As a further example, the TU partition of block 1350 is composed of three W/4×H TUs 1360A-C, as shown in (f).

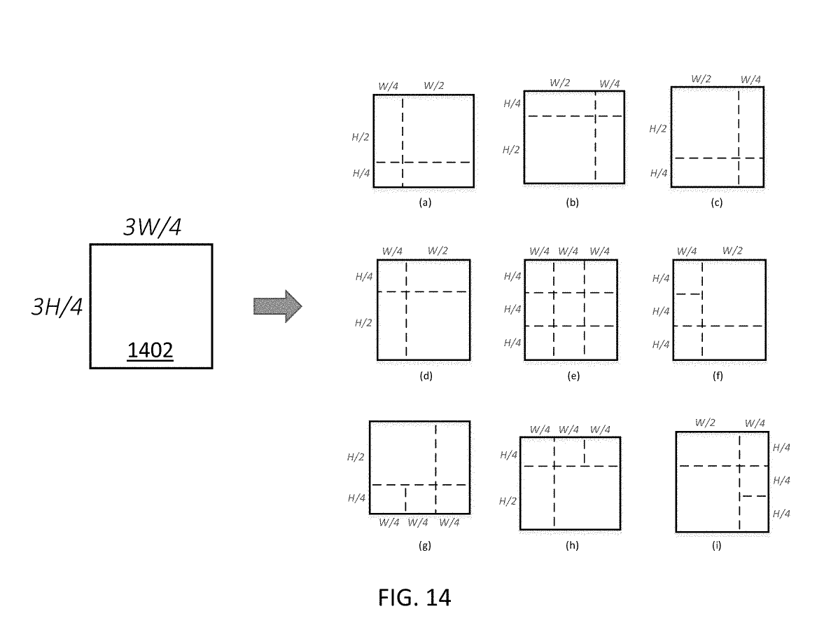

In some embodiments, if a block width and height are not a power of 2, then the TU partition of the block is implicitly indicated. Several methods can be used to implicitly indicate (e.g., or to determine) the TU partition. FIG. 14 shows examples of implicitly indicating the TU partition, according to some embodiments. FIG. 14 shows block 1402 with a width and height of 3W/4. In one example, the TU partition for block 1402 is composed of four transform blocks, as shown in (a)-(d). In another example, the TU partition of block 1402 is composed of nine transform blocks, as shown in (e). In a further example, the TU partition of block 1402 is composed of five transform blocks, as shown in (f)-(i).

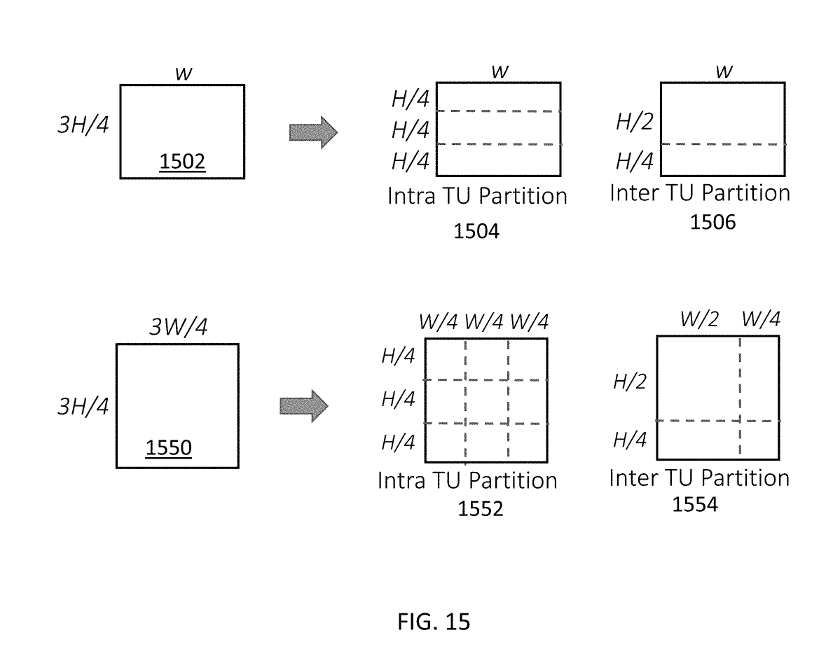

In some embodiments, if a block width and height are not a power of 2, then the TU partition could be implicitly and conditionally indicated according to the intra/inter coding mode. FIG. 15 shows examples of implicitly indicating the TU partition according to coding mode, according to some embodiments. For example, for a block 1550 with a width 3W/4 and a height 3H/4, the TU partition used in intra mode is partition 1552, composed of nine W/4×H/4 transform blocks, and the TU partition used in inter mode is partition 1506, composed of a W/2×H/2, a W/2×H/4, a W/4×H/2 and W/4×H/4 TU (or in some other order).

Other methods can be used to implicitly indicate the TU partition. For example, the TU partition for intra coded block can be assigned to the partition type in 14(e). The TU partition for an inter coded block can be assigned to one of the partition types in FIG. 14. As another example, the TU partition for an intra coded block can be set to one of the partition types in FIG. 14. The TU partition for inter coded block can be assigned to one of the partition types in FIG. 14(a)-(d).

In some embodiments, if a block width is not the power of 2, then the TU partition could be implicitly and conditionally indicated according to the intra/inter coding mode. For example, the TU partition used in intra mode is composed of three W/4×H transform blocks, and the TU partition used in inter mode is firstly composed of a W/2×H and then a W/4×H transform blocks. As another example, the TU partition used in intra mode is composed of three W/4×H transform blocks, and the TU partition used in inter mode is firstly composed of a W/4×H and then a W/2×H transform blocks.

In some embodiments, if a block height is not the power of 2, then the TU partition could be implicitly and conditionally indicated according to the intra/inter coding mode. For example, referring further to FIG. 15, for a block 1502 with a width W and a height 3H/4, the TU partition used in intra mode is partition 1504, composed of three W×H/4 transform blocks, and the TU partition used in inter mode is partition 1506, composed of a W×H/2 and a W×H/4 transform block (or in the opposite order).

In some embodiments, if a block width or height is not a power of 2, a syntax element can be used to explicitly indicate the TU partition. The syntax element can be signaled in a video parameter set (VPS), a sequence parameter set (SPS), a picture parameter set (PPS), a slice header, a coding unit, and/or the like. In some embodiments, the constraint comprises a series of values to split the side into many segments in power of two. For example, given a 24×12 unit, for the side with a length of 24, a series of values can be {0, 1, 1}, indicating to split the side into 16 and 8 (e.g., 4×0, 8×1, and 16×1). Similarly, for the side of 12, a series of values can be {1, 1}, indicating to split the side into 8 and 4 (e.g., 4×1, and 8×1). In this example, the indication is only for the side that is not a power of 2. For example, given a 8×12 unit, only the side of 12 needs to be indicated, and a series of values can be {3}, indicating to split the side into 4, 4, and 4 (e.g., 4×3).

In some embodiments, if a block height is not a power of 2, the TU partition could be implicitly and/or explicitly indicated according to the intra/inter coding mode. For example, the TU partition used in intra coding mode can be composed of three W×H/4 transform blocks, and a syntax element can be used to explicitly indicate the TU partition used in inter mode. In another example, a syntax element can be used to explicitly indicate the TU partition used in intra mode, and the TU partition used in inter mode can be firstly composed of a W×H/4 and then a W×H/2 transform block. The syntax element can be signaled in VPS, SPS, PPS, slice header, a CU, and/or the like.

In some embodiments, if a block width is not a power of 2, the TU partition could be implicitly and/or explicitly indicated according to the intra/inter coding mode. For example, the TU partition used in intra mode is composed of three W/4×H transform blocks, and a syntax element is used to explicitly indicate the TU partition used in inter mode. In another example, a syntax element is used to explicitly indicate the TU partition used in intra mode, and the TU partition used in inter mode is firstly composed of a W/4×H and then a W/2×H transform blocks. The syntax element can be signaled in VPS, SPS, PPS, slice header, a CU, and/or the like.

If a block width and height are not a power of 2, the TU partition could be implicitly and/or explicitly indicated according to the intra/inter coding mode. For example, the TU partition used in intra mode is the partition type in FIG. 14(e). A syntax element is used to explicitly indicate the TU partition for inter coded. As another example, a syntax element can be used to indicate the TU partition for intra coded block. The TU partition for the inter coded block can be implicitly assigned to the one of the partition types in FIG. 14(a)-(d).

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. An image or video encoding method comprising:
partitioning a slice of an image or video sequence into a set of first units;
for each first unit in the set of first units, partitioning the first unit into a set of second units, comprising, for each second unit in the set of second units:
determining whether the second unit satisfies a predetermined constraint;
if the second unit does not satisfy the predetermined constraint, testing a first set of partitioning techniques to partition the second unit;
if the second unit satisfies the predetermined constraint, testing the first set of partitioning techniques and a second set of partitioning techniques to partition the second unit; and
partitioning the second unit using a technique from the first set of partitioning techniques or the second set of partitioning techniques identified by the testing.

2. The method of claim 1, wherein:
the first unit is a coding tree unit; and
the second unit is a coding unit or a prediction unit.

3. The method of claim 1, wherein:
the first set of partitioning techniques comprises:
a quad-tree partitioning technique that partitions the second unit using a quad-tree;
a binary tree partitioning technique that partitions the second unit using a binary tree;
a no partitioning technique that no further partitions in the second unit, or some combination thereof; and
the second set of partitioning techniques comprises:
an asymmetric coding unit partitioning technique that asymmetrically partitions the second unit;
a triple-tree partitioning technique that partitions the second unit using a triple tree, or some combination thereof.

4. The method of claim 1, wherein the constraint comprises one or more of:
a size of the second unit, a tree split depth of the second unit, whether the second unit is a leaf node of a split tree; whether the width of the second unit is a power of two; whether the height of the second unit is a power of two, or any combination thereof.

5. The method of claim 4, wherein the constraint is implicitly indicated, explicitly indicated, or both.

6. The method of claim 4, further comprising explicitly indicating the constraint in a video bitstream, wherein the constraint is signaled in a video parameter set (VPS), a sequence parameter set (SPS), a picture parameter set (PPS), a slice header, a coding unit, or any combination thereof.

7. The method of claim 6, wherein the constraint comprises:
a minimum length and a maximum length of a width of the second unit;
a height of the second unit;
a minimum and a maximum tree split depths, or any combination thereof.

8. An image or video encoding method comprising:
partitioning a slice of an image or video stream into a set of first units;
for each first unit in the set of first units, partitioning the first unit into a set of second units, comprising, for each second unit in the set of second units:
determining whether the second unit satisfies a predetermined constraint;
if the second unit satisfies the predetermined constraint, testing a first set of partitions to partition the second unit, each partition from the set of partitions comprising a same partition direction;
if the second unit does not satisfy the predetermined constraint, testing a second set of partitions to partition the second unit, the partitions in the second set of partitions including the first set of partitions and additional partitions with a different direction than the first set of partitions; and
partitioning the second unit using a partition from the first set of partitions or the second set of partitions identified by the testing.

9. The method of claim 8, wherein the constraint comprises one or more of:
a minimum length and a maximum length of a width of the second unit, a height of the second unit, or both;
whether the height of the second unit, the width of the second unit, or both, are a power of two;
or any combination thereof.

10. The method of claim 9, further comprising explicitly indicating the constraint in a video bitstream, wherein the constraint is signaled in a video parameter set (VPS), a sequence parameter set (SPS), a picture parameter set (PPS), a slice header, a coding unit, or any combination thereof.

11. The method of claim 10, wherein the constraint comprises:
a minimum length and a maximum length of a width of the second unit;
a height of the second unit, or both.

12. The method of claim 8, wherein a partitioning technique associated with the set of partitions is signaled.

13. An image or video encoding method comprising:
partitioning a slice of an image or video stream into a set of first units;
for each first unit in the set of first units, partitioning the first unit into a set of second units, comprising, for each second unit in the set of second units:
determining the second unit satisfies a predetermined constraint;
testing a set of partitions to partition the second unit, each partition from the set of partitions comprising a set of sub-units comprising a width meeting a second constraint, a height meeting the second constraint, or both;
partitioning the second unit using a partition from the set of partitions identified by the testing.

14. The method of claim 13, wherein the constraint comprises a width of the second unit not being a power of two, a height of the second unit not being a power of two, or both.

15. The method of claim 13, wherein the second constraint comprises the length being a power of two.

16. The method of claim 13, wherein the second constraint is implicitly determined based on a coding mode.

17. The method of claim 16, wherein the coding mode comprises an intra coding mode or an inter coding mode.

18. The method of claim 13, wherein the second constraint is explicitly indicated in a signal.

19. The method of claim 18, further comprising explicitly indicating the signal by a video parameter set (VPS), a sequence parameter set (SPS), a picture parameter set (PPS), a slice header, a coding unit, or any combination thereof.

20. The method of claim 19, wherein the constraint comprises:
each side of the second unit is not a power of two;
a series of values to split the side into many segments in power of two, or both.

21. The method of claim 13, wherein:
the first unit is a coding tree unit; and
the second unit is a coding unit or a prediction unit.

22. (canceled)

23. (canceled)

24. (canceled)

25. An image or video decoding method comprising:
receiving a bitstream, wherein the bitstream was encoded by:
partitioning a slice of an image or video sequence into a set of first units;
for each first unit in the set of first units, partitioning the first unit into a set of second units, comprising, for each second unit in the set of second units:
determining whether the second unit satisfies a predetermined constraint;
if the second unit does not satisfy the predetermined constraint, testing a first set of partitioning techniques to partition the second unit;
if the second unit satisfies the predetermined constraint, testing the first set of partitioning techniques and a second set of partitioning techniques to partition the second unit; and
partitioning the second unit using a technique from the first set of partitioning techniques or the second set of partitioning techniques identified by the testing; and
decoding the received bitstream.

26. The method of claim 25, wherein the constraint is explicitly indicated in the bitstream, wherein the constraint is signaled in a video parameter set (VPS), a sequence parameter set (SPS), a picture parameter set (PPS), a slice header, a coding unit, or any combination thereof.

27. An image or video decoding method comprising:
receiving a bitstream, wherein the bitstream was encoded by:
partitioning a slice of an image or video stream into a set of first units;
for each first unit in the set of first units, partitioning the first unit into a set of second units, comprising, for each second unit in the set of second units:
determining whether the second unit satisfies a predetermined constraint;
if the second unit satisfies the predetermined constraint, testing a first set of partitions to partition the second unit, each partition from the set of partitions comprising a same partition direction;
if the second unit does not satisfy the predetermined constraint, testing a second set of partitions to partition the second unit, the partitions in the second set of partitions including the first set of partitions and additional partitions with a different direction than the first set of partitions; and
partitioning the second unit using a partition from the first set of partitions or the second set of partitions identified by the testing; and
decoding the received bitstream.

28. The method of claim 27, wherein the constraint is explicitly indicated in the bitstream, wherein the constraint is signaled in a video parameter set (VPS), a sequence parameter set (SPS), a picture parameter set (PPS), a slice header, a coding unit, or any combination thereof.

29. An image or video decoding method comprising:
receiving a bitstream, wherein the bitstream was encoded by:
partitioning a slice of an image or video stream into a set of first units;
for each first unit in the set of first units, partitioning the first unit into a set of second units, comprising, for each second unit in the set of second units:
determining the second unit satisfies a predetermined constraint;
testing a set of partitions to partition the second unit, each partition from the set of partitions comprising a set of sub-units comprising a width meeting a second constraint, a height meeting the second constraint, or both; and
partitioning the second unit using a partition from the set of partitions identified by the testing; and
decoding the received bitstream.

30. The method of claim 29, wherein the second constraint is explicitly indicated in the signal by a video parameter set (VPS), a sequence parameter set (SPS), a picture parameter set (PPS), a slice header, a coding unit, or any combination thereof.

31. (canceled)

32. (canceled)

33. (canceled)
